(19) United States
(12) Patent Application Publication
(10) Pub. No.: US 2013/0095007 A1
(43) Pub. Date: Apr. 18, 2013

(54) BUFFY COAT SEPARATOR FLOAT SYSTEMS AND METHODS

(71) Applicants: Thomas D. Haubert, Columbus, OH (US); Herbet S. Bresler, Bexley, OH (US)

(72) Inventors: Thomas D. Haubert, Columbus, OH (US); Herbet S. Bresler, Bexley, OH (US)

(73) Assignee: BATTELLE MEMORIAL INSTITUTE, Columbus, OH (US)

(21) Appl. No.: 13/638,037

(22) PCT Filed: Mar. 30, 2011
(86) PCT No.: PCT/US2011/030414

§ 371 Date: Dec. 11, 2012

Related U.S. Application Data
(60) Provisional application No. 61/318,903, filed on Mar. 30, 2010.
(60) Provisional application No. 61/372,889, filed on Aug. 12, 2010.

(51) Int. Cl. B04B 7/08

(52) U.S. Cl. CPC B04B 7/08
USPC 422/533

(57) ABSTRACT

Tube and float systems for separation and axial expansion of the buffy coat are provided. Generally, the systems include a flexible sample tube and a rigid separator float having a specific gravity intermediate that of red blood cells and plasma. The sample tube has an elongated sidewall having a first cross-sectional inner diameter. The float has a main body portion and one or more support members protruding from the main body portion to engage and support the sidewall of the sample tube. During centrifugation, the centrifugal force enlarges the diameter of the tube to permit density-based axial movement of the float in the tube. After centrifugation is ended, the tube sidewall returns to its first diameter, thereby capturing the float and trapping the buffy coat constituents in an annular volume. Several different systems for capturing and retrieving the buffy coat constituents are described.

This application claims priority to U.S. Provisional Patent Application Ser. No. 61/318,903, filed on Mar. 30, 2010, and to U.S. Provisional Patent Application Ser. No. 61/372,889, filed on Aug. 12, 2010. The disclosure of these applications is hereby fully incorporated by reference.

### BACKGROUND OF THE DISCLOSURE

The present disclosure relates generally to density-based fluid separation, and in particular to improved sample tubes and float designs for the separation, identification, and/or quantification of fluid compounds by axial expansion, and methods employing the same. The present disclosure finds particular application in blood separation and axial expansion of the buffy coat layers, and will be described with particular reference thereto.

Quantitative Buffy Coat (QBC) analysis is routinely performed in clinical laboratories for the evaluation of whole blood. The buffy coat is a series of thin, light-colored layers of white cells that form between the layer of red cells and the plasma when unclotted blood is centrifuged or allowed to stand.

QBC analysis techniques generally employ centrifugation of small capillary tubes containing anticoagulated whole blood, to separate the blood into essentially six layers: (1) packed red cells, (2) reticulocytes, (3) granulocytes, (4) lymphocytes/monocytes, (5) platelets, and (6) plasma. The buffy coat consists of the layers, from top to bottom, of platelets, lymphocytes and granulocytes and reticulocytes.

Based on examination of the capillary tube, the length or height of each layer is determined during the QBC analysis and converted into a cell count, thus allowing quantitative measurement of each layer. The length or height of each layer can be measured with a manual reading device, i.e., a magnification eyepiece and a manual pointing device, or photometrically by an automated optical scanning device that finds the layers by measuring light transmittance and fluorescence along the length of the tube. A series of commonly used QBC instruments are manufactured by Becton-Dickinson and Company of Franklin, Lakes, N.J.

Since the buffy coat layers are very thin, the buffy coat is often expanded in the capillary tube for more accurate visual or optical measurement by placing a plastic cylinder, or float, into the tube. The float has a density less than that of red blood cells (approximately 1.090 g/ml) and greater than that of plasma (approximately 1.028 g/ml) and occupies nearly all of the cross-sectional area of the tube. The volume-occupying float, therefore, generally rests on the packed red blood cell layer and expands the axial length of the buffy coat layers in the tube for easier and more accurate measurement.

There exists a need in the art for an improved sample tube and float system and method for separating blood and/or identifying circulating cancer and/or other rare cells, organisms or particulates or objects (i.e., stem cells, cell fragments, virally-infected cells, trypanosomes, etc.) in the buffy coat or other layers in a blood sample. However, the number of cells expected to be typically present in the buffy coat is very low relative to the volume of blood, for example, in the range of about 1-100 cells per millimeter of blood, thus making the measurement difficult, particularly with the very small sample sizes employed with the conventional QBC capillary tubes and floats.

The present disclosure contemplates new and improved blood separation assemblies and methods that overcome the above-referenced problems and others.

### BRIEF DESCRIPTION

The present application discloses, in various embodiments, apparatuses and methods for separating and axially expanding the buffy coat constituents in a blood sample. The apparatuses include separator floats and sample tubes.

Disclosed herein are methods of separating and axially expanding buffy coat constitutents in a blood sample; detecting target cells in a blood sample; and capturing or extracting buffy coat constitutents/target cells in a blood sample. Those methods require introducing the blood sample and a rigid volume-occupying float into a flexible sample tube. The rigid float has a specific gravity intermediate that of red blood cells and plasma, and comprises a main body portion spacedly surrounded radially by the sidewall of the sample tube to form an annular volume therebetween; and one or more support members protruding from the main body portion and engaging the sidewall. The sample tube is centrifuged at a rotational speed that causes enlargement of the sidewall to a diameter sufficiently large to permit axial movement of the float, separation of the blood into discrete layers, and movement of the float into alignment with at least the buffy coat constituents of the blood sample. The rotational speed is reduced to cause the sidewall to capture the float and trap buffy coat constituents in the annular volume, which might be divided into one or more analysis areas.

Some methods disclosed herein further comprise welding at least one of the one or more support members to the sidewall.

Other methods further comprise combining the blood sample with one or more labeling agents so as to differentiate the target cells from other cells in the blood sample. This can be performed prior to centrifugation or during later processing after centrifugation. The blood sample present in one or more analysis areas in the annular volume can also be examined to identify any target cells contained therein.

Disclosed in further embodiments is a sample tube for holding a sample. The sample tube comprises a sidewall, which has a first cross-sectional inner diameter, and interior surface, and an exterior surface. One or more circumferential notches, cuts, or indentations are made on the sidewall of the sample tube to facilitate the breaking, splitting, or separation of the tube at each notch. Usually, the notch is a V-shaped or U-shaped depression in the surface of the sidewall; however, other configurations are also contemplated.

The circumferential notches can be located on the exterior surface or the interior surface of the sidewall of the sample tube. The notches can also be continuous around the circumference, or discontinuous. In particular embodiments, the one or more circumferential notches comprise two sets of notches that divide the tube into three volumes.

In methods using the sample tube with circumferential notches, after centrifugation, the sample tube is broken at at least one of the one or more notches to obtain a broken or isolated section of the tube containing the float and expanded buffy coat constituents.

The one or more circumferential notches can comprise two sets of notches that divide the tube into three volumes. Desirably, one set of notches is above the float and one set of notches is below the float after reducing the rotational speed. No broken notches should be made or be present along the axial length of the float.

Also disclosed in embodiments is a sample tube comprising a cylinder which has a first open end and a second open end. Two closure devices are provided for sealing the two ends.

In methods using the sample tube with two closure devices, the closure devices are removed after centrifugation. This allows red blood cells and plasma to be emptied from the sample tube to isolate the float and expanded buffy coat layer. Examples of such closure devices include removable fitted or screw type cpas, but other closure devices are also contemplated.

Further disclosed are some methods wherein at least a portion of the buffy coat constituents contained in the annular volume are removed through the sidewall of the sample tube using a removal device.

Different float designs are also provided herein. In some embodiments, a volume-occupying separator float has a specific gravity intermediate that of red blood cells and plasma. The float comprises a main body portion having atop end and a bottom end; and one or more support members protruding from the main body portion. The main body portion and the one or more support members define an annular volume. The main body portion also contains a septum for receiving a pitot tube, the septum extending from a top end of the main body portion to the annular volume.

In other embodiments, the separator float includes a pitot tube having a distal end, wherein the pitot tube engages the septum at the top end, and wherein the distal end is located away from the top end of the main body portion.

In methods using such floats having a septum, the septum is engaged with the pitot tube. At least a portion of the buffy coat layer is removed from the annular volume through the pitot tube.

Additionally disclosed are different volume-occupying separator floats. These floats comprise a main body portion; a top support member extending radially from atop end of the main body portion; and a bottom support member extending radially from a bottom end of the main body portion. An annular volume is defined by the main body portion, the top support member, and the bottom support member. One or more intermediate support members extend radially from the main body portion to form a plurality of wells in the annular volume. A plurality of septums is present within the main body portion, each septum allowing access to a particular well from the top end of the main body portion.

In some further embodiments, the one or more intermediate support members consist of a plurality of axially oriented ridges. In others, the one or more intermediate support members consist of a plurality of circumferentially oriented ridges. In still others, the one or more intermediate support members consist of a plurality of axially oriented ridges intersecting with a plurality of circumferentially oriented ridges.

In still other embodiments, a volume-occupying separator float comprises a main body portion having a top end and a bottom end; a bottom support member extending radially from the bottom end of the main body portion; and a plurality of ridges extending radially from the main body portion and extending axially between the top end of the main body portion and the bottom support member to form at least one axially extending flute. The float may consist of one axially extending flute or a plurality of axially extending flutes. At least a portion of the buffy coat constituents can be extracted from such flutes using an extraction device, like a syringe.

Other methods include examining the plurality of flutes; identifying a target cell in one or more of the plurality of flutes; and extracting the buffy coat constituents only from the flute(s) containing the target cell.

Other methods of using a float with a flexible sleeve are also disclosed herein. Generally, the blood sample and float are introduced into the flexible sleeve, then centrifuged. The sleeve is used to seal at least one of the wells to trap the buffy coat constituents in wells in the float.

In some embodiments, the sleeve comprises a sidewall, the sidewall having a polygonal cross-sectional shape with n sides. The float also has n sides. After centrifugation, the sleeve shrinks and attaches to the float, trapping at least a portion of the buffy coat constituents in the n wells. For example, such a sleeve can be triangular in a lateral cross-sectional configuration (i.e. n=3), square (i.e n=4), pentagonal (i.e. n=5), etc.

Some floats described herein comprise a main body portion having a top end, a bottom end, and n sides, wherein n is an integer greater than two. A top support member extends laterally away from the top end of the main body portion, and a bottom support member extends laterally away from the bottom end of the main body portion. A plurality of ridges is also present, each ridge extending laterally away from the main body portion and extending axially from the top support member to the bottom support member to form n axially-oriented wells, each well having an exterior surface. The float is adapted to be unfolded so that the exterior surfaces of the wells can lie substantially in the same plane.

Methods using the unfolding float include unfolding the float to place at least two wells into substantially the same plane.

Some volume-occupying floats disclosed herein comprise a main body portion having atop end and a bottom end. One or more support members protrude from the main body portion, and a hollow internal cavity is present within the main body portion. The main body portion and the one or more support members define an annular volume, and one or more one-way valves permit flow from the annular volume to the hollow internal cavity. A plug may be present at the top end of the main body portion for accessing the hollow internal cavity.

Such floats are used by evacuating at least a portion of the buffy coat constituents into the hollow internal cavity; bleeding a fluid into the annular volume; and removing the buffy coat constituents from the hollow internal cavity using a removal device, such as a syringe.

Another similar volume-occupying separator float comprises two main body portions. A first main body portion comprises a sidewall that defines a central bore, the central bore being accessible from a top end. A bottom support member extends radially from a bottom end of the sidewall. A first thread is located within the central bore. One or more one-way valves are located in the sidewall and directed to permit entry of fluid into a bottom end of the central bore. The second main body portion comprises a center portion sized to fit within the central bore and a complementary thread located on the center portion for engaging the first thread of the first main body portion. A top support member extends radially from a top end of the second main body portion. This float operates by being unscrewed to increase the volume in the central bore.

This float may further comprise a plug at the top end of the second main body portion for accessing the central bore. This float also generally comprises a keyhole in the second main body portion for unscrewing the second main body portion from the first main body portion.

When the second main body portion is unscrewed, the the second main body portion moves upward, reducing the pressure in the central bore, and evacuating at least a portion of the buffy coat constituents into the central bore. A fluid can subsequently be bled into the annular volume.

Another volume-occupying separator float also comprises two main body portions. The first main body portion comprises a cylinder that defines a central bore, the central bore being accessible from a top end. A bottom support member extends radially from a bottom end of the cylinder. One or more one-way valves located in the cylinder are directed to permit entry of fluid into a bottom end of the central bore. The second main body portion comprises a center portion sized to slidably fit within the central bore, and a top support member extending radially from a top end of the second main body portion.

This float is used by sliding the second main body portion axially upward to decrease the pressure in the central bore; evacuating at least a portion of the buffy coat constituents into the central bore; and bleeding a fluid into the annular volume.

These and other non-limiting characteristics of the disclosure are more particularly disclosed below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a side view of a sample tube containing a volume-occupying separator float.

FIG. 2 is a diagram illustrating the methods of the present disclosure.

FIG. 3A is a side view of a notched sample tube containing a volume-occupying separator float therein.

FIG. 3B is a perspective view of a continuous notch on a notched sample tube.

FIG. 3C is a perspective view of a discontinuous notch on a notched sample tube.

FIG. 3D is a side view of a rectangular notch on a notched sample tube.

FIG. 3E is a side view of a triangular notch on a notched sample tube.

FIG. 4 is a side view of an exemplary sample tube having two open ends which are each sealed with a closure device and containing a volume-occupying separator float therein.

FIG. 5 is a side view of an apparatus comprising a sample tube, a volume-occupying separator float within the sample tube, and a syringe penetrating the sidewall of the sample tube to access the annular volume.

FIG. 6 is a side view of a sample tube containing a volume-occupying separator float that has a pitot tube extending through the float to access the annular volume.

FIG. 7 is a perspective view of a volume-occupying separator float having axial intermediate support members that form axial wells.

FIG. 8 is a side view of a volume-occupying separator float having circumferential intermediate support members that form circumferential.

FIG. 9 is a perspective view of a volume-occupying separator float having axial intermediate support members and circumferential intermediate support members that intersect to form a plurality of wells.

FIG. 10 is a top perspective view of a volume-occupying separator float having a single axial flute.

FIG. 11 is a top perspective view of a volume-occupying separator float having a plurality of axial flutes.

FIG. 12 is a cross-sectional view of a portion of a flexible sleeve containing a volume-occupying separator float therein.

FIG. 13 is a perspective view of a flexible sleeve containing a volume-occupying separator float with a square cross-section.

FIG. 14 is a perspective view of a volume-occupying separator float which has been unfolded.

FIG. 15 is a side view of a volume-occupying separator float with a one-way valve permitting flow from the annular volume of the float into a hollow internal cavity.

FIG. 16 is a side view of another volume-occupying separator float. The float has two pieces which are threaded together.

FIG. 17 is a side view of another volume-occupying separator float. The float has two pieces which are slidably engaged.

FIG. 18 is a side view of another volume-occupying separator float. The float has sharp support members.

### DETAILED DESCRIPTION

A more complete understanding of the components, processes, and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range of “from about 2 to about 10” also discloses the range “from 2 to 10.”

The present disclosure relates generally to apparatuses and assemblies which are useful for separating, identifying, capturing, and/or quantifying the various components of a blood sample, based on the density of the various components. Those apparatuses include volume-occupying separator floats, sample tubes, and combinations thereof.

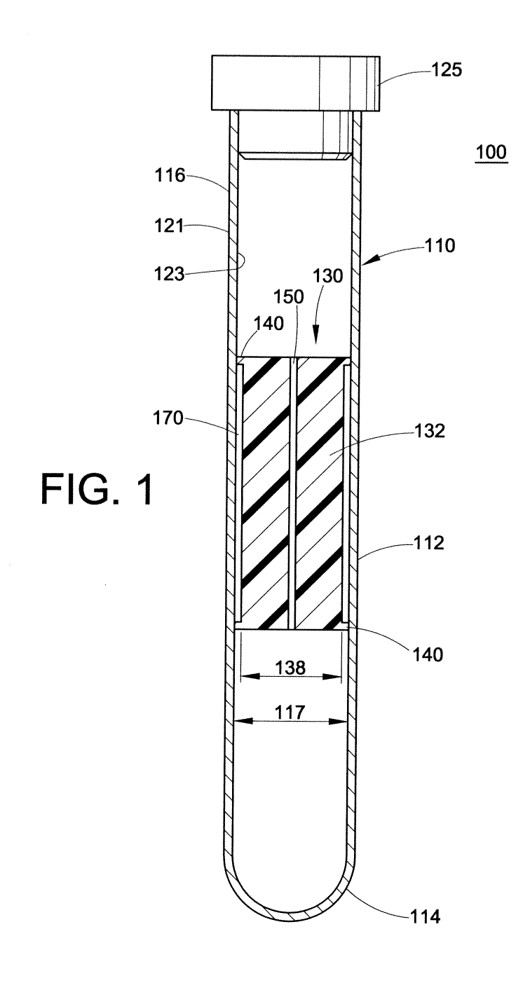

FIG. 1 is an axial cross-section of a blood separation tube and float assembly 100. The assembly includes a sample tube 110 and a separator float or bobber 130 placed therein.

The sample tube 110 is generally cylindrical. However, sample tubes having polygonal and other geometrical cross-sectional shapes are also contemplated. In other words, the sample tube may have a cross-section that is a polygon having n sides. For example, when n=3, the sample tube has a triangular cross-section. In particular, the sample tube may have a regular polygonal cross-section (i.e. the lengths of each side are substantially equal).

The sample tube 110 includes a first, closed end 114 and a second, open end 116 receiving a stopper or cap 125. Other closure means are also contemplated, such as parafilm or the like. In alternative embodiments, discussed further herein, the sample tube may be open at each end, with each end receiving an appropriate closure device.

Although the tube is depicted as generally cylindrical, the tube 110 may be minimally tapered, slightly enlarging toward the open end 116, particularly when manufactured by an injection molding process. This taper or draft angle is generally necessary for ease of removal of the tube from the injection molding tool.

The tube 110 is formed of a transparent or semi-transparent material and the sidewall 112 of the tube 110 is sufficiently flexible or deformable such that it expands in the radial direction during centrifugation, e.g., due to the resultant hydrostatic pressure of the sample under centrifugal load. As the centrifugal force is removed, the tube sidewall 112 substantially returns to its original size and shape. The sidewall 112 has an exterior surface 121 and an interior surface 123.

The tube may be formed of any transparent or semi-transparent, flexible polymeric material (organic and inorganic), such as polystyrene, polycarbonate, styrene-butadiene-styrene (“SBS”), styrene/butadiene copolymer (such as “K-Resin®” available from Phillips 66 Co., Bartlesville, Okla.), etc. Preferably, the tube material is transparent. However, the tube does not necessarily have to be clear, as long as the receiving instrument that is looking for the cells or items of interest in the sample specimen can “see” or detect those items in the tube. For example, items of very low level of radioactivity that cannot be detected in a bulk sample can be detected through a non-clear or semi-transparent wall after it is separated by the process of the present disclosure and trapped near the wall by the float 130 as described in more detail below. Desirably, the sample tube is seamless, at least along those portions of the tube along which the float will travel.

In some embodiments, the tube 110 is sized to accommodate the float 130 plus at least about five milliliters of blood or sample fluid, more preferably at least about eight milliliters of blood or fluid, and most preferably at least about ten milliliters of blood or fluid. In particular embodiments, the tube 110 has an inner diameter 117 of about 1.5 cm and accommodates at least about ten milliliters of blood in addition to the float 130.

The float 130 depicted here includes a main body portion 132 and two sealing rings or flanges 140, disposed at opposite axial ends of the float 130. The main body portion 132 and the sealing rings or support members 140 of the float 130 are sized to have an outer diameter which is less than the inner diameter 117 of the sample tube 110, under pressure or centrifugation. Put another way, the outer diameter of the support members is substantially equal to the inner diameter 117 of the sample tube 110 in a non-flexed state, so that the float can be held in a particular location by the sample tube. The main body portion 132 of the float 130 also has a smaller outer diameter 138 which is less than the diameter of the sealing or support rings 140, thereby defining an annular volume 170 between the float 130 and the sidewall 112 of the tube 110. The main body portion occupies much of the cross-sectional area of the tube, with the annular volume 170 being large enough to contain the cellular components of the buffy coat layers (i.e. buffy coat constituents) and associated target cells when the tube is in the non-flexed state. Preferably, the dimensions 138 and 117 are such that the annular volume 170 has a radial thickness ranging from about 25 microns to about 250 microns, most preferably about 50 microns. It should be noted that the term “annular” is used to refer to the ring-like shape formed by the float within the tube, and should not be construed as requiring the shape to be defined by two concentric circles. Rather, the tube and the float may each have different shapes and “annular” refers to the shape formed between them. The number of support members 140 may also vary, as will be seen further herein.

A bore or channel 150 extends axially through the float 130. When the tube/float system is centrifuged, the tube expands, freeing the float in the blood sample. As centrifugation is slowed, the float is captured by the sidewall 112 of the tube as the sube returns to its original diameter. As the tube continues to contract, pressure may build up in the blood fraction trapped below the float, primarily red blood cells. This pressure may cause red cells to be forced into the annular volume 170 containing the captured buffy coat constituents, thus diluting the contents or making imaging of the contents of the buffy coat more difficult. Alternatively, the collapse of the side wall of the sample tube during deceleration may produce excessive or disruptive fluid flow through the separated buffy coat layers. The bore 150 allows for any excessive fluid flow or any resultant pressure in the dense fractions trapped below the float 130 to be relieved. The excessive fluid flows into the bore 150, thus preventing degradation of the buffy coat sample. This bore can be considered a pressure relief means for inhibiting excessive fluid flow through the buffy coat constituents. The bore is depicted here as being central and axially aligned within the float 130, but other configurations are contemplated so long as the bore extends completely through the float from one end to the other. In some embodiments, the bore 150 is centrally located and axially extending.

While in some instances the outer diameter 138 of the main body portion 132 of the float 130 may be less than the inner diameter 117 of the tube 110, this relationship is not required. This is because once the tube 110 is centrifuged (or pressurized), the tube 110 expands and the float 130 moves freely. Once the centrifugation (or pressurization) step is completed, the tube 130 constricts back down on the sealing rings or support ridges 140 to capture the float. The annular volume 170 is then created, and sized by the length of the support ridges or sealing rings 140 (i.e., the depth of the “pool” is equal to the length of the support ridges 140, independent of what the tube diameter is/was).

In desired embodiments, the float dimensions are 3.5 cm tall×1.5 cm in diameter, with a main body portion sized to provide a 50-micron gap for capturing the buffy coat layers of the blood. Thus, the volume available for the capture of the buffy coat layer is approximately 0.08 milliliter. Since the entire buffy coat layer is generally less than about 0.5% of the total blood sample, the preferred float accommodates the entire quantity of buffy layer separated in an eight to ten milliliter sample of blood.

The sealing or support flanged ends 140 are sized to be substantially equal to, or slightly greater than, the inner diameter 117 of the tube. The float 130, being generally rigid, can also provide support to the flexible tube wall 112. Furthermore, the support members 140 provide a sealing function to maintain separation of the blood constituent layers. The seal formed between the support members 140 of the float and the wall 112 of the tube may form a fluid-tight seal. As used herein, the term “seal” is also intended to encompass near-zero clearance or slight interference between the flanges 140 and the tube wall 112 providing a substantial seal which is, in most cases, adequate for purposes of the disclosure.

The support members 140 are most preferably continuous ridges, in which case the sample may be centrifuged at lower speeds and slumping of the separated layers is inhibited. However, in alternative embodiments which are discussed further herein, the support members can be discontinuous or segmented bands having one or openings providing a fluid path in and out of the annular gap 170. The support members 140 may be separately formed and attached to the main body portion 132. Preferably, however, the support members 140 and the main body portion 132 form a unitary or integral structure.

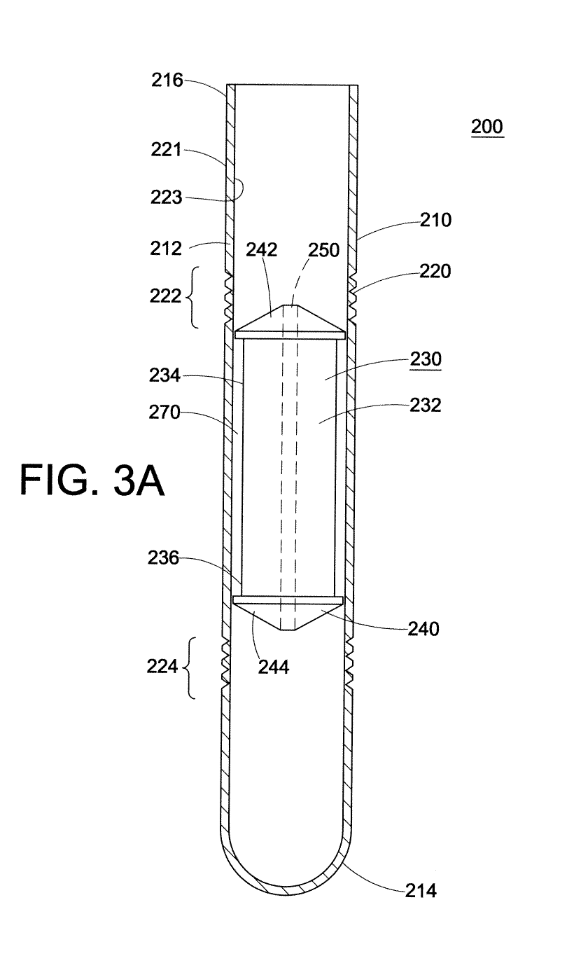

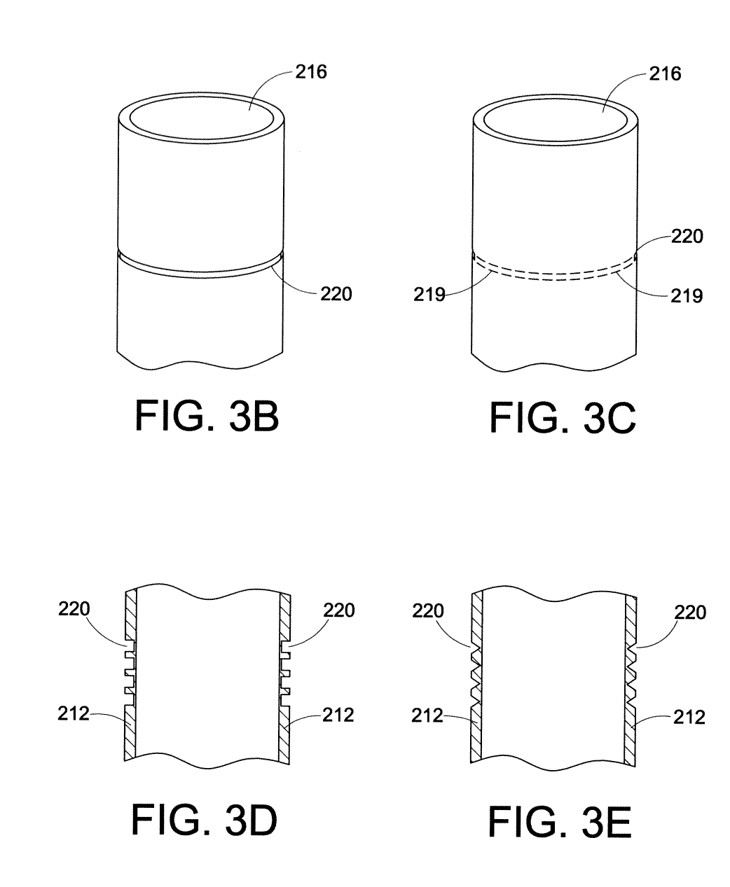

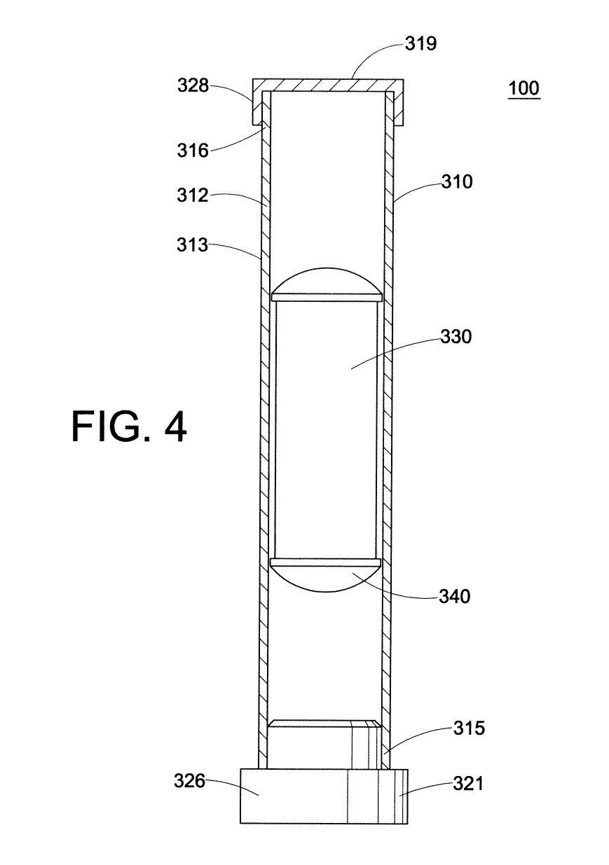

The geometrical configuration of the support members are exemplary only, and different configurations are contemplated. For example, the support member 140 in FIG. 1 is flat; the support member 240 in FIG. 3A is tapered away from the main body portion 232; and the support member 340 in FIG. 4 is concave curved. These shapes can provide a surface that encourages flow of the blood around the float during centrifugation. Additional exemplary shapes contemplated include, but are not limited to, tectiform and truncated tectiform; three, four, or more sided pyramidal and truncated pyramidal, ogival or truncated ogival; geodesic shapes, and the like.

The overall specific gravity of the separator float 130 should be between that of red blood cells (approximately 1.090) and that of plasma (approximately 1.028). In more specific embodiments, the specific gravity is in the range of from about 1.089 to about 1.029, more preferably from about 1.070 to about 1.040, and most preferably about 1.05.

The float may be formed of multiple materials having different specific gravities, so long as the overall specific gravity of the float is within the desired range. The overall specific gravity of the float 130 and the volume of the annular gap 170 may be selected so that some red cells and/or plasma may be retained within the annular gap, as well as the buffy coat layers. Upon centrifuging, the float 130 occupies the same axial position as the buffy coat layers and target cells and floats on the packed red cell layer. The buffy coat is retained in the narrow annular gap 170 between the float 130 and the inner wall 112 of the tube 110. The expanded buffy coat region can then be examined, under illumination and magnification, to identify circulating epithelial cancer or tumor cells or other target analytes.

In embodiments, the density of the float 130 is selected to settle in the granulocyte layer of the blood sample. The granulocytes settle on, or just above, the packed red-cell layer and have a specific gravity of about 1.08-1.09. In this preferred embodiment, the specific gravity of the float is in this range of from about 1.08 to about 1.09 such that, upon centrifugation, the float settles in the granulocyte layer. The amount of granulocytes can vary from patient to patient by as much as a factor of about twenty. Therefore, selecting the float density such that the float settles in the granulocyte layer is especially advantageous since loss of any of the lymphocyte/monocyte layer, which settles just above the granulocyte layer, is avoided. During centrifugation, as the granulocyte layer increases in size, the float settles higher in the granulocytes and keeps the lymphocytes and monocytes at essentially the same position with respect to the float. In other embodiments described further herein, the float may be made from two pieces, and the specific gravity of each piece may differ.

The float 130 is formed of one or more generally rigid organic or inorganic materials, preferably a rigid plastic material, such as polystyrene, acrylonitrile butadiene styrene (ABS) copolymers, aromatic polycarbonates, aromatic polyesters, carboxymethylcellulose, ethyl cellulose, ethylene vinyl acetate copolymers, nylon, polyacetals, polyacetates, polyacrylonitrile and other nitrile resins, polyacrylonitrile-vinyl chloride copolymer, polyamides, aromatic polyamides (aramids), polyamide-imide, polyarylates, polyarylene oxides, polyarylene sulfides, polyarylsulfones, polybenzimidazole, polybutylene terephthalate, polycarbonates, polyester, polyester imides, polyether sulfones, polyetherimides, polyetherketones, polyetheretherketones, polyethylene terephthalate, polyimides, polymethacrylate, polyolefins (e.g., polyethylene, polypropylene), polyallomers, polyoxadiazole, polyparaxylene, polyphenylene oxides (PPO), modified PPOs, polystyrene, polysulfone, fluorine containing polymer such as polytetrafluoroethylene, polyurethane, polyvinyl acetate, polyvinyl alcohol, polyvinyl halides such as polyvinyl chloride, polyvinyl chloride-vinyl acetate copolymer, polyvinyl pyrrolidone, polyvinylidene chloride, specialty polymers, and so forth., and most preferably polystyrene, polycarbonate, polypropylene, acrylonitrite butadiene-styrene copolymer (“ABS”) and others.

In this regard, it is desirable to avoid the use of materials and/or additives that interfere with the detection or scanning method. For example, if fluorescence is utilized for detection purposes, the material utilized to construct the float 130 should not have interfering or “background” fluorescence at the wavelength of interest.

In some aspects, the compressibility and/or rigidity of the flexible tube and rigid float can be reversed. The float is flexible and designed to shrink in diameter at the higher pressures and moves freely within a rigid tube. The use of a compressible float allows for usage of transparent glass tubes which, in some instances, exhibit enhanced optical properties over polymeric tubes. Furthermore, this aspect generally reduces the tolerance requirements for the glass tubes (since the float would expand up against the tube wall after the pressure decreases), and a full range of float designs is possible.

The method for detecting circulating epithelial cancer cells in a blood of a subject is disclosed in U.S. Pat. No. 6,197,523 may advantageously be modified to employ the sample tube and float system of the subject disclosure. The aforementioned U.S. Pat. No. 6,197,523 is incorporated herein by reference in its entirety.

In an exemplary method of using the tube/float system 100 of the disclosure, a sample of anticoagulated blood is provided. For example, the blood to be analyzed may be drawn using a standard Vacutainer® or other like blood collection device of a type having an anticoagulant predisposed therein. Alternatively, a flexible sample tube may be used to directly capture the blood to be analyzed.

A tag, such as a fluorescently labeled antibody or ligand, which is specific to the target epithelial cells or other target analytes of interest, can be added to the blood sample and incubated prior to centrifugation. In an exemplary embodiment, the epithelial cells are labeled with anti-epcam having a fluorescent tag attached to it. Anti-epcam binds to an epithelial cell-specific site that is not expected to be present in any other cell normally found in the blood stream. A stain or colorant, such as acridine orange, may also be added to the sample to cause the various cell types to assume differential coloration for ease of discerning the buffy coat layers under illumination and to highlight or clarify the morphology of epithelial cells during examination of the sample.

The blood is then transferred to the assembly 100 for centrifugation. The float 130 may be introduced into the tube 110 after the blood sample is introduced into the sample tube 110 or otherwise may be placed therein beforehand. The tube and float assembly 100 containing the sample is then centrifuged. Operations required for centrifuging the blood by means of the subject tube/float system 100 are not expressly different from the conventional case, although, as stated above, reduced centrifuge speeds may be possible and problems of slumping may be reduced. An adaptor may optionally be utilized in the rotor to prevent failure of the flexible tube due to stress.

During centrifugation, the sample tube is spun at a rotational speed sufficient to cause several effects. In particular, the resultant hydrostatic pressure deforms or flexes the wall 112 so as to enlarge the diameter of the tube from a first cross-sectional inner diameter to a second diameter, the second diameter being greater than the first diameter. The second diameter is sufficiently large to permit the blood components and the float 130 to move axially under centrifugal force within the tube 110. The blood sample is separated into six discrete and distinct layers according to density, which are, from bottom to top (most dense to least dense): packed red blood cells, reticulocytes, granulocytes, lymphocytes/monocytes, platelets, and plasma. The epithelial cells sought to be imaged tend to collect by density in the buffy coat layers, i.e., in the granulocyte, lymphocyte/monocyte, and platelet layers. Due to the density of the float, the float occupies the same axial position within the sample tube as the buffy coat layers/constituents which thus occupy the narrow annular volume 170, potentially along with a small amount of the red cell and/or plasma). Put another way, the float moves into alignment with at least the buffy coat constituents of the blood sample.

After centrifugal separation is complete and the centrifugal force is removed, the tube 110 returns to its original diameter to capture or retain the float and the buffy coat layers and target analytes within the annular volume 170. The tube/float system can be transferred to a microscope or optical reader to identify any target analytes in the blood sample. Depending on the subsequent use of the float, the annular volume may be considered to make up one or more analysis areas.

Centrifugation may not be required. Sometimes the application of pressure alone to the inside of the tube, or simply the expansion of the tube (or the compression of the float) is required. For example, such pressure can be produced through the use of a vacuum source on the outside of the tube. Such an application also allows for the top of the sample tube to be kept open and easily accessible. Additionally, the use of a vacuum source may be easier to implement in some situations than the application of a centrifugal force. Additionally, any method of tubular expansion/contraction (or float compression) such as mechanical, electrical, magnetic, etc., can be implemented. Once the tube is expanded (or the float is compressed), the float will move to the proper location due to buoyancy forces created by the density variations within the sample.

In additional embodiments described herein, a removal device, such as a syringe. is then used to extract the buffy coat layers/constituents from the annular volume. The intent here is to extract the target cells of interest, so it is acceptable to remove some of the red blood cells and/or plasma during this process as well. If tags have not yet been added, they may be added now to tag or label the “target” cells of interest. Again, the tags are any kind that an analytical instrument or detector could detect, e.g. fluorescent, radioactive, etc. The tags may be in the removal device itself, or they can be added separately.

The sample is then applied, such as by being “squirted”, through the instrument/detector and the tagged cells are analyzed. It may be sufficient to count the number of tagged cells. However, in further embodiments, the ‘positive’ sample cells are diverted into a holder for further analysis. Means of separating such cells are known in the art and can be similar to those used in flow cytometry, for example by coordinating the timing of the instrument/detector with the holder. The positive sample can then be further analyzed, for example by preparing a slide for further examination. This ‘squirt-n-divert’ method results in a smaller sample volume that is easier to analyze compared to the original blood sample, which was many times larger.

The float can comprise a part of a collection tube system or assembly. Thus, it is not necessary to transfer the buffy coat sample from a collection container to an analysis tube. The blood or sample fluid can be collected immediately and then tested. Such a system is somewhat faster, and also safer from a biohazard standpoint. For example, this system is desirable in very contagious situations (i.e. Ebola virus, HIV, etc.) where any type of exposure of the blood must be minimized.

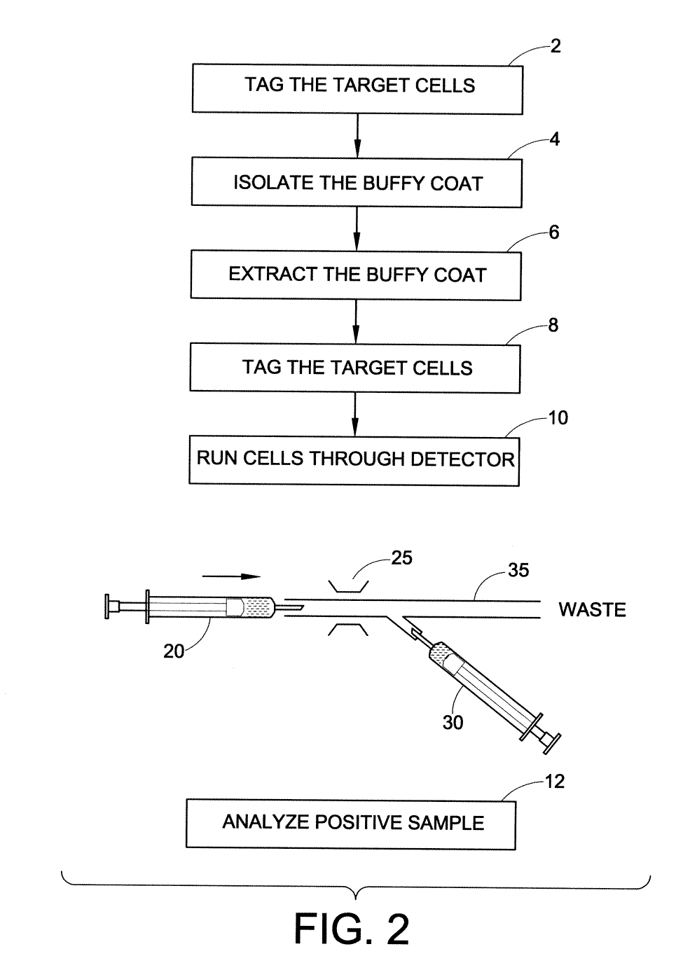

FIG. 2 is a diagram illustrating some of the general methods described above. In step 2, the target cells in the buffy coat layers of the blood sample can be tagged prior to centrifugation. In step 4, the buffy coat is isolated, e.g. by centrifugation. In step 6, the sample containing the buffy coat, and reduced in volume compared to the original blood sample, is extracted from the sample tube. In step 8, if the target cells were not already tagged, they can be tagged now. Alternatively, they can be tagged using different tags suitable for use with the given instrument/detector. In step 10, the reduced volume is run through the detector. As illustrated here, the reduced volume with the tagged target cells begin in syringe 20 and are injected into detector 25 which separates the ‘positive’ sample (i.e. target cells) and diverts them into holder 30. The ‘negative’ sample goes to waste 35, i.e. is disposed of. Finally, in step 12, the positive sample is further analyzed.

The sample tubes, separator floats, and methods described above provide a general idea of the present disclosure. Several further concepts are described herein.

Several different means are possible to remove the buffy coat layers/constituents from the sample tube. In some embodiments, the blood sample and float are introduced into the sample tube, the tube is centrifuged, and the rotational speed is then reduced to trap the buffy coat constituents in the annular volume. Next, at least one support member 140 is welded to the sidewall 112 of the sample tube 110. This weld traps the buffy coat layers within the annular volume, which can now be considered an enclosed toroid and in which the buffy coat layers are separated from the plasma and/or red blood cells.

The weld may be continuous about a circumference of the welded member, i.e. the perimeter where the support member contacts the sidewall. The weld may also be discontinuous, i.e. there are gaps in the weld. In particular embodiments, the welding is performed ultrasonically. Ultrasonic welding is an industrial technique commonly used for plastics, whereby high-frequency ultrasonic acoustic vibrations are locally applied to two items being held together to create a solid-state weld between the two items. The term “welding” is used here to indicate the action of joining the float with the sample tube in a specific location, and is synonymous with melting.

In some embodiments, a flexible sleeve is placed in the sample tube, and the float and blood sample are then placed into the flexible sleeve. In these embodiments, the at least one support member 140 may be welded to the sleeve.

Referring to FIG. 3A, in particular embodiments, the separator float 230 includes a main body portion 232 having a top end 234 and a bottom end 236. A top support member 242 extends radially from the top end 234, and a bottom support member 244 extends radially from the bottom end 236. The sidewall 212, main body portion 232, top support member 242, and bottom support member 244 together define an annular volume 270. In preferred embodiments, both the top and bottom support members are welded to the sample tube. An axial bore 250 is present for pressure relief of the red blood cell portion below the buffy coat layers.

The blood separation apparatus 200 shown in FIG. 3A also shows another exemplary embodiment of a sample tube 210. The sample tube 210 includes a sidewall 212, a first, closed end 214, a second, open end 216, and circumferential notches 220. A circumferential notch is formed by one or more grooves that lie substantially within the same plane, that plane being perpendicular to the sidewall of the tube. A first set 222 of notches is located above the float 130 and a second set 224 of notches is located below the float. Each set is shown here in FIG. 3 with three notches, but this number can vary and is generally between one and four notches in each set. The sample tube is broken along one or more notches to get access to the float and the buffy coat layers trapped in the annular volume 270.

FIGS. 3B-3E illustrate different variations of the notches. In FIG. 3B, the depicted set has one notch which is formed by one continuous groove 219, i.e. the notch is continuous around the circumference. In FIG. 3C, the depicted notch is formed by a set of short grooves 219, i.e. the notch is discontinuous around the circumference. In FIG. 3D, the set has two notches, each of which is rectangularly shaped, while in FIG. 3E, the notch is triangularly shaped. In other words, the notch may have a triangular or rectangular axial cross-section. Other notch shapes, such as U-shaped, are also contemplated. These forms may be useful in directing how the tube breaks. Although the notches 220 in FIG. 3A are on the exterior surface 221 of the sample tube 210, the notches could be located on the interior surface 223 of the sample tube 210 and should not interfere with axial movement of the float. The sample tube may only have a single notch in some embodiments. However, in desirable embodiments, the sample tube 210 comprises a first set 222 of notches and a second set 224 of notches, which divide the tube into three volumes 225, 227, 229.

Again, the blood sample and float are introduced into the sample tube 210, the tube is centrifuged, and the rotational speed is then reduced to trap the buffy coat constituents in the annular volume. Methods using the sample tube 210 further include breaking the sample tube 210 at at least one of the one or more notches 220 to obtain a section of the tube 210 containing the float 230 and annular volume 270 which contains the buffy coat constituents. In certain preferred embodiments, at least one notch in the first set 222 of notches above the float 130 and at least one notch in the second set 224 of notches below the float 230 are broken. The tube may be broken, for example, by simple twisting or snapping. The annular volume 270 can be examined to identify target cells either before or after breaking the tube, as desired.

Desirably, the amount of blood introduced into the sample tube is controlled so that after centrifugation, the float 230 is located in the middle volume 225 of the tube 210. As seen in FIG. 3A, no notches are present along the axial length 231 of the float. This result aids in ensuring that breakage and consequent loss of the buffy coat layers does not occur.

Sealing glass ampules are known that allow the lower bulb, containing a sample, to be sealed off. Typically, such ampules have a constriction to which heat is applied to soften the glass. The glass collapses, forming the seal, and the lower bulb is gently pulled away from the remainder of the tube. Such sealed ampules differ from the sample tube of FIG. 3A in that the glass material of the tube completely surrounds the sample, whereas here the separator float itself provides one or two surfaces that surround the buffy coat sample. In addition, such sealed ampules typically seal their sample in the lower bulb, i.e. the ampule is divided into two volumes. In contrast, the sample tube of FIG. 3A can be divided into three volumes. Finally, the breaking of the sample tube is easier and less time-consuming than heating and sealing the ampule.

FIG. 4 shows another concept of a blood separation apparatus 300 including a sample tube 310 and a separator float 330. The sample tube 310 is formed from a sidewall 312, shown here as a cylinder 313, though the tube may generally have any lateral cross-sectional shape. The sidewall defines a first open end 315 and a second open end 316, which are opposite each other. A first closure device 326 closes the first end 315 and a second closure device 328 closes the second end 316. The closure device can be an exterior cap, such as cap 319, that does not penetrate into the cylinder, or an interior cap such as a stopper 321, that does penetrate into the cylinder, or any combination thereof.

When the apparatus of FIG. 4 is used, the first closure device 326 seals the first end 315 during centrifugation. The second end 316 may be sealed with the second closure device 328 or left open. At the end of centrifugation, the first closure device 326 and/or the second closure device 328 are then removed to access the float and the expanded buffy coat layer. In particular, the two-cap design advantageously allows the plasma and the red blood cells to be drained from the sample tube 310, leaving the expanded buffy coat layer in the cylinder 313 to be analyzed. If desired, this concept can also be combined with the notches 220 described above, so that a sample tube has circumferential notches and two open ends, the tube being broken at the notches after draining the plasma and the red blood cells.

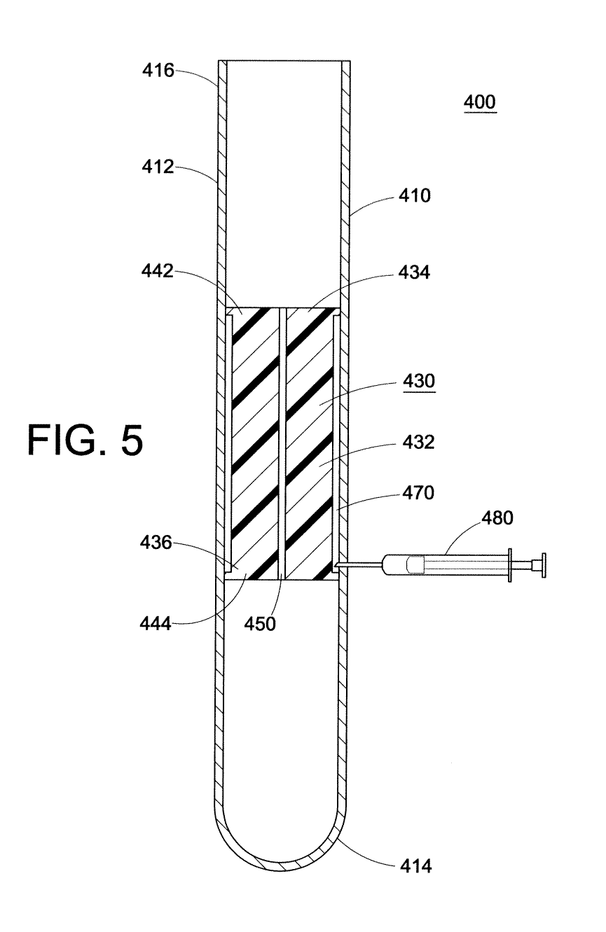

The buffy coat constituents can also be withdrawn from the annular volume by other means. FIG. 5 shows a blood separation apparatus 400 including a sample tube 410 and a separator float 430. The sample tube 410 has a sidewall 412, a first end 414 and a second end 416. The separator float 430 as depicted includes a main body portion 432 having a top end 434 and a bottom and 436, top support member 442 and bottom support member 444 extending radially from the main body portion 432, and a pressure relief means, such as axial bore 450 extending from the top end 434 through the bottom end 436. An annular volume 470 is formed between the main body portion 432 and sidewall 412.

When the apparatus of FIG. 5 is used to separate buffy coat constituents, at least a portion of the buffy coat constituents is removed from the annular volume 470 through the sidewall 412 using a removal device, such as syringe 480. In this regard, the sidewall is typically formed of a material that is generally sturdy enough to withstand the forces generated by centrifugation, but that can be penetrated by syringe 480. Preferably, the material can seal the small hole made in the sidewall by the removal device. The criteria for selecting the material include high clarity, injection molding grade, high flow, medium-low modulus, low shrinkage, and cost. In this regard, suitable materials for forming the sample tube 410 may include acrylics, polyethylene terephthalate glycol (PETG), polycarbonate, polystyrenes, styrene-butadiene-styrene polymers, and TOPAS polymers (amorphous, transparent copolymers based on cyclic olefins and ethylene).

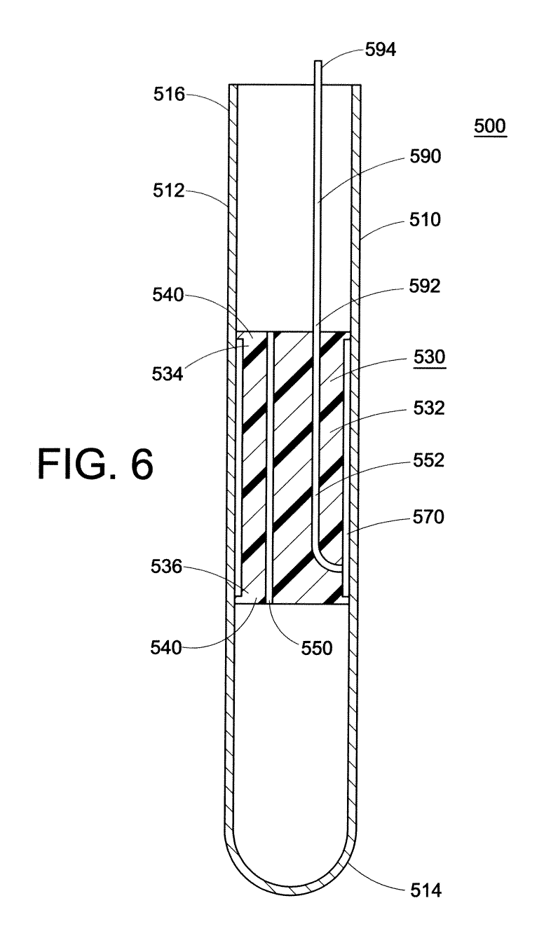

Another concept is illustrated in FIG. 6. Here, a blood separation apparatus 500 includes a sample tube 510, a separator float 530, and a pitot tube 590. The sample tube 510 includes a sidewall 512, a first, closed end 514, and a second, open end 516. The separator float 530 includes a main body portion 532 having a top end 534 and a bottom end 536, and one or more support members 540 extending radially from the main body portion 532. A septum 552 is present in the main body portion 532, and the septum extends from the top end 534 to the annular volume 570. An axial bore 550 also extends from the top end 534 through the bottom end 536.

The pitot tube 590 has a proximal end 592 and a distal end 594. An internal passage 593 is of course present in the tube, and runs between the proximal and distal ends. The proximal end 592 engages the septum 552 at the top end 534 of the main body portion 532 and the distal end 594 is located away from the top end 534. The separator float 530 and the pitot tube 590 may be separate pieces or one integral unit.

When the apparatus of FIG. 6 is used to separate buffy coat constituents, the buffy coat layers/constituents in the annular volume 570 can be removed through the pitot tube 590, for example by applying vacuum. In this respect, a pitot tube acts like a straw; fluid flows through the pitot tube when the pressure at the top of the pitot tube is lower than the pressure at the bottom of the pitot tube. When the pitot tube 590 and septum 552 are not integral, the pitot tube 590 engages the septum 552 prior to removal of the buffy coat layers/constituents.

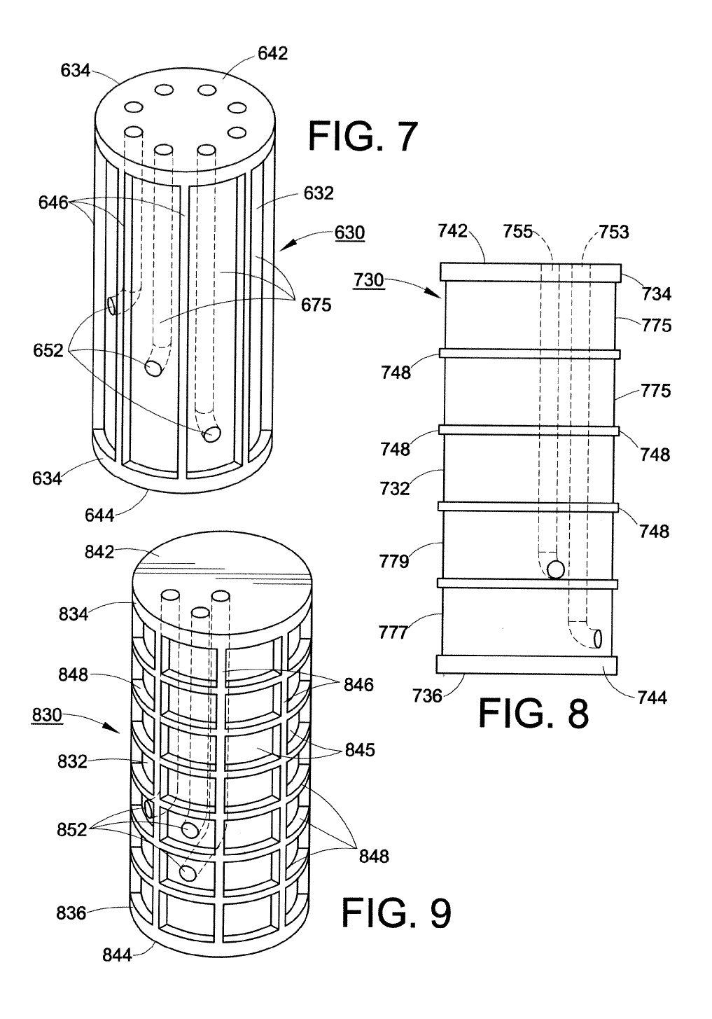

FIGS. 7-9 show different embodiments of a common concept. As seen in FIG. 1, a separator float comprises a main body portion, a top support member, and a bottom support member which define an annular volume in which the buffy coat constituents are trapped. While the float reduces the volume of the blood sample which must be analyzed to locate target cells of interest, it is possible to reduce the volume even further by dividing the annular volume into wells which can be individually accessed. Put another way, the volume within each well can be removed separately from the volume of another well. To accomplish this, the float further includes one or more intermediate support members that form a plurality of wells in the annular volume, i.e. divide the annular volume into a plurality of wells. A plurality of septums is also present within the main body portion, and each septum allows access to, or provides access to, a particular well from the top end of the main body portion. When the buffy coat constituents are removed from a particular well, a fluid, such as air, can be bled into that well to replace the extracted volume. For example, the buffy coat constituents may be drawn out via syringe inserted through the tube sidewall near the bottom of the well while, simultaneously, the sidewall may be pierced at the top of the same well to allow air in to replace the buffy coat constituents. Alternatively, the sample tube adjacent to a particular well may be pierced in two different places to create two ports. Pressure could then be applied to the first port to pump buffy coat constituents out of the second port. A syringe may also be inserted through the float into a well to extract the contents from that well.

In FIG. 7, separator float 630 includes a main body portion 632 having a top end 634 and a bottom end 636, a top support member 642 extending radially from the top end 634, and a bottom support member 644 extending radially from the bottom end 636. The intermediate support members 640 in this embodiment consist of a plurality of axial ridges 646. The axial ridges extend radially from the main body portion and also extend axially between the top support member 634 and bottom support member 644. The axial ridges generally extend radially the same distance from the main body portion as the top support member and the bottom support member. Each axial well 675 is defined by the main body portion 632, top support member 642, bottom support member 644, and two axial ridges 646. It is generally contemplated that each axial well 675 will have the some volume, though this is not a requirement. Each axial well has its own septum 652, allowing access to the axial well 675 from the top end 634 of the main body portion 632. It may be desirable for the septum to access the axial well near the bottom end 636 of the main body portion.

In FIG. 8, separator float 730 includes a main body portion 732 having a top end 734 and a bottom end 736, a top support member 742 extending radially from the top end 734, and a bottom support member 744 extending radially from the bottom end 736. The intermediate support members in this embodiment consist of a plurality of circumferential ridges 748. The circumferential ridges extend radially from the main body portion and form a plurality of circumferential wells 775 in the volume defined by the main body portion 732, top support member 742, and bottom support member 744. Each well 775 is defined by the main body portion 732 and at least one circumferential ridge 748. The circumferential ridges generally extend radially the same distance from the main body portion as the top support member and the bottom support member. It is generally contemplated that each well 775 will have the same volume, though this is not a requirement. Each well has its own septum 752, allowing access to the well 775 from the top end 734 of the main body portion 732. In particular embodiments, the septum of each well accesses the well proximal to the support member nearest the bottom end 736 of the main body portion. For example, septum 753 accesses well 777 proximal to bottom support member 744, while septum 755 accesses well 779 proximal to circumferential ridge 781.

In FIG. 9, separator float 830 includes a main body portion 832 having a top end 834 and a bottom end 836, atop support member 842 extending radially from the top end 834, and a bottom support member 844 extending radially from the bottom end 836. The intermediate support members in this embodiment consist of a plurality of axial ridges 846 and a plurality of circumferential ridges 848. These ridges 846, 848 generally extend radially the same distance from the main body portion as the top support member and the bottom support member. The axial ridges 846 intersect the circumferential ridges 848 to form a plurality of wells 875 in the volume defined by the main body portion 832, top support member 842, and bottom support member 844. It is generally contemplated that each well 875 will have the same volume, though this is not a requirement. Each well has its own septum 852, allowing access to a particular well 875 from the top end 834 of the main body portion 832. It may be desirable for the septum to access each well as proximal the bottom end 636 of the main body portion as possible.

When the floats of FIGS. 7-9 are used to separate buffy coat consitutents, the buffy coat layer in a specific well can be extracted using an extraction device such as a syringe or a pitot tube. In particular, the annular volume is first examined to identify the well in which a target cell is located, and only the fluid in that well is extracted for closer analysis.

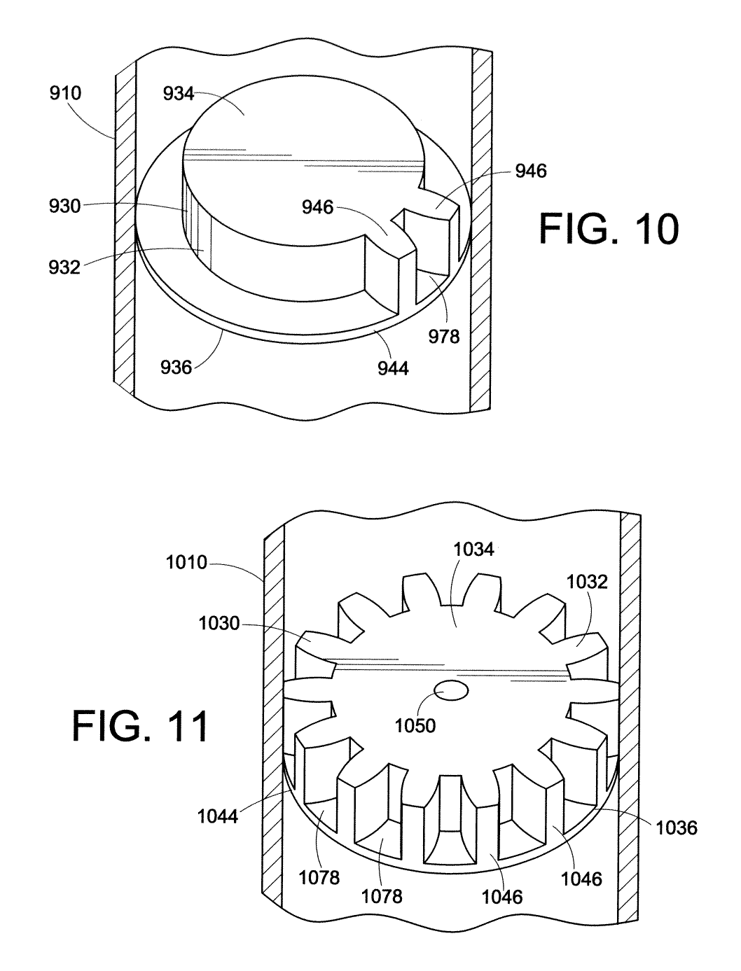

FIG. 10 and FIG. 11 show a related concept. FIG. 10 shows a sample tube 910 and a separator float 930. Separator float 930 includes a main body portion 932 having a top end 934 and a bottom end 936, and a bottom support member 944 extending radially from the bottom end 936. A plurality of axial ridges 946 extend radially from the main body portion 932 and also extend axially between the top end 934 and bottom support member 944. The axial ridges generally extend radially the same distance from the main body portion as the bottom support member. The axial ridges 946 form an axially extending flute 978. Here, the liquid in the flute 978 is accessible from the top end 934 without the need to include a septum in the main body portion. This may reduce the complexity and cost needed to manufacture the float.

FIG. 11 shows a sample tube 1010 and a separator float 1030. The separator float 1030 includes a main body portion 1032 having a top end 1034 and a bottom end 1036, a bottom support member 1044 extending radially from the bottom end 1036, and a plurality of axial ridges 1046 extending between the top end 1034 and the bottom support member 1044 to form a plurality of flutes 1078 between the axial ridges. An axial bore 1050 is also depicted for relieving pressure differences between the top end 1034 and bottom end 1036.

When the floats of FIG. 10 and FIG. 11 are used, at least a portion of the buffy coat constituents in a specific flute 978, 1078 is extracted using an extraction device such as a syringe or a pitot tube. In particular, the annular volume is first examined to identify the flute in which a target cell is located, and only the fluid in that flute is extracted for closer analysis.

In additional concepts, a flexible sleeve is used in conjunction with the float. The blood sample and float are placed in the flexible sleeve, which can then be placed into a sample tube. The flexible sleeve itself may be semi-transparent or transparent. After centrifugation, the flexible sleeve is used to seal the buffy coat layers into wells on the float. The sealed wells can then be treated as small slides for analysis.

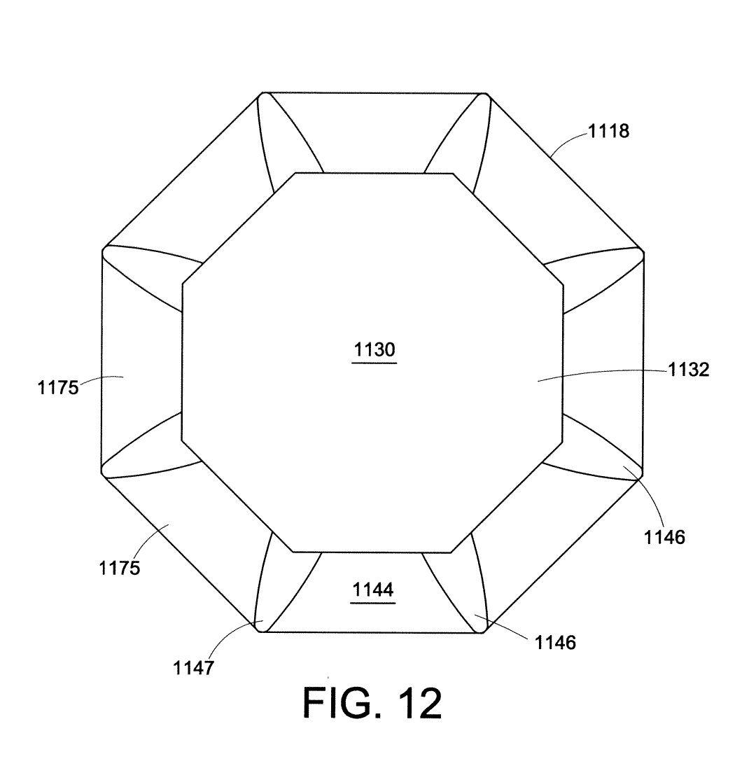

FIG. 12 shows a top cross-sectional view of a flexible sleeve 1118 and a separator float 1130 exemplifying one concept. The separator float 1130 includes a main body portion 1132 and a plurality of axial ridges 1146. The axial ridges extend radially from the main body portion and also extend axially between the top end (not shown) and the bottom end (not shown) of the main body portion. A bottom support member 1144 is generally present, and a top support member (not seen) may also be present. The ridges generally extend radially the same distance from the main body portion as the bottom support member and the top support member. A plurality of wells 1175 is formed by the ridges. It should be noted that the end 1147 of each ridge 1146 is rounded; this reduces perforation of the flexible sleeve.

The flexible sleeve 1118 generally has a cross-sectional diameter which is less than the diameter of the separator float 1130; this encourages sealing/stretching of the sleeve over the wells 1175. Upon centrifugation, the diameter of the flexible sleeve increases, permitting axial movement of the float so that the float can be aligned with the buffy coat constituents. Upon reducing the rotational speed, the sleeve captures the float. At least one well 1175 is then sealed with the sleeve 1118 to trap a portion of the buffy coat constituents. The sleeve may be held in place by friction, i.e. because of its smaller diameter, or the sleeve can be welded as described above. If no top support member is present, then the buffy coat constituents in a specific well can be removed using a removal device, such as a syringe or a pitot tube, if desired. It should also be noted that if desired, the float can be asymmetrical, i.e. shaped so that the main body portion is not coaxial with the axis of the sample tube or so that different wells have different volumes.

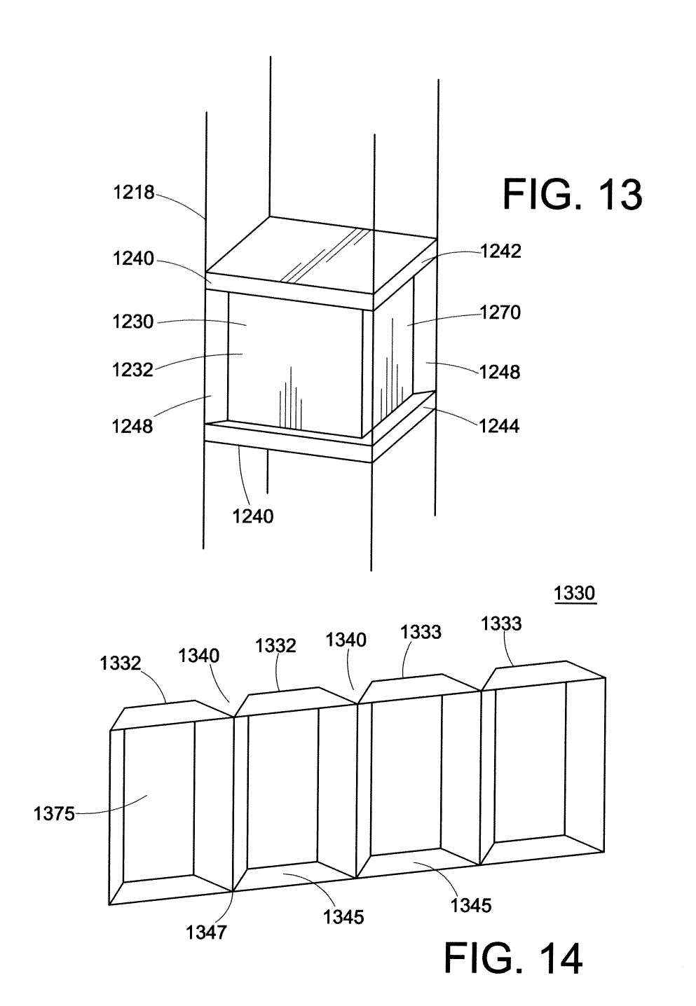

In a related concept, the flexible sleeve has a polygonal cross-sectional shape with n sides, and the float also has n wells. As illustrated in FIG. 13, both flexible sleeve 1218 and a separator float 1230 have a four sided cross-sectional shape. The flexible sleeve has a sidewall 1212 having a four-sided cross-sectional shape. In some embodiments, the lateral cross-section of the sidewall and the float is a regular polygon having n sides. Generally, n is an integer greater than two, and in particular embodiments is three, four, or five (i.e. triangular, square, or pentagon). The float will consequently have n axially-oriented ridges 1248 on corners between the sides to define the wells. It should be noted that again, the wells may be of different volumes. However, generally, all of the wells have the same dimensions and volumes.

The separator float 1230 includes a main body portion 1232 and one or more support members 1240 extending radially from the main body portion 1232. In preferred embodiments, the main body portion 1232 has top support member 1242 extending from top end 1234 and bottom support member 1244 extending from bottom end 1236. Annular volume 1270 is defined by the main body portion 1232 and the sidewall 1212.

Again, the flexible sleeve 1218 generally has a cross-sectional diameter which is less than the diameter of the separator float 1230; this encourages sealing/stretching of the sleeve over the wells 1275. Upon centrifugation, the diameter of the flexible sleeve increases, permitting axial movement of the float so that the float can be aligned with the buffy coat constituents. Upon reducing the rotational speed, the sleeve shrinks and attaches to the float. The wells can be sealed or welded with the sleeve, if desired. Due to the flat surface provided by the sleeve, the wells can then be analyzed like a slide.

In an extension of this concept, the float can be unfolded so that the wells can be analyzed like a stick. FIG. 14 shows a separator float 1330 exemplifying this concept. The separator float 1330 has been unfolded in this depiction. The separator float includes a main body portion 1332 and four axially oriented ridges 1340 extending laterally from the main body portion 1332. A top support member (not shown) and a bottom support member (not shown) also extend laterally from the main body portion. The top support member, bottom support member, and axial ridges generally extend radially the same distance from the main body portion. The float thus defines wells 1375 between the ridges 1340, support members, and main body portion 1332. The main body portion 1332 of the float is adapted to be unfolded so that the exterior surfaces 1345 of the wells can lie substantially in the same plane. Put another way, the main body portion 1332 in this embodiment can be regarded as four different parts 1333, each part providing a surface for each well 1375. The float can be unfolded, for example, by providing thinner material at the end 1347 of each ridge 1340 that is bent, by providing hinges, or other similar methods. Essentially, each ridge acts as a hinge to allow the float to be unfolded. An axial bore can easily be formed by providing that the parts 1333 do not form a solid upon being joined together.

After centrifugation and reduction of the rotational speed, the sleeve shrinks and seals the buffy coat layers/constituents, again by sealing or welding if desired. The float 1330 is unfolded to place the exterior surfaces 1345 of the wells 1375 into substantially the same plane. Another advantage here is that the sleeve may be more easily punctured by a removal device, such as a syringe.

In another set of concepts, the buffy coat constituents are trapped in the annular volume between the sample tube and the float as described above. The buffy coat constituents are than evacuated into a cavity in the main body portion of the float. The buffy coat constituents are then removed from this cavity. If desired, the float containing the buffy coat constituents can be removed from the sample tube, and the buffy coat constituents subsequently removed from the float. Alternatively, the buffy coat constituents can be removed from the float while the float is still in the tube. For example, this concept could be combined with the two-cap sample tube of FIG. 4 to remove the plasma and/or red blood cells prior to accessing the cavity in the float.

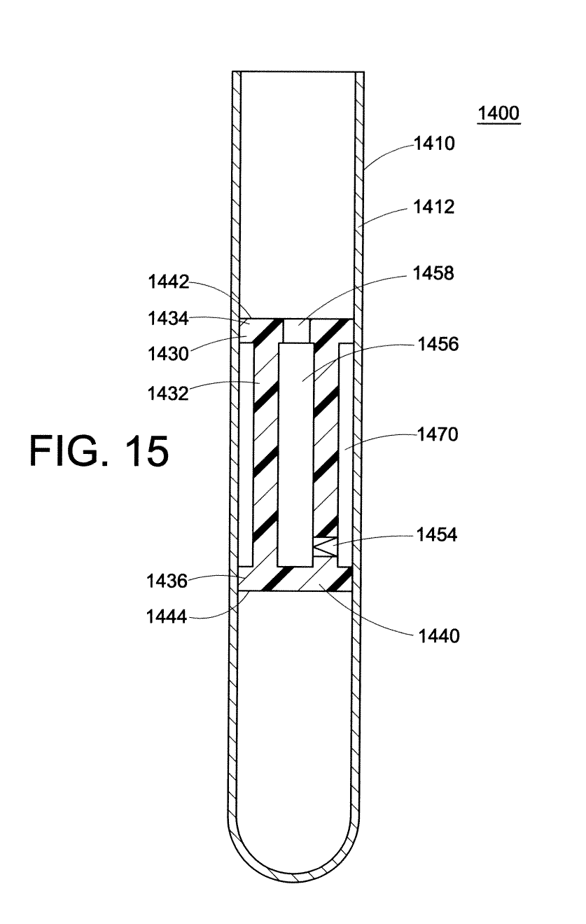

FIG. 15 shows an exemplary embodiment of this concept. Blood separation apparatus 1400 includes a sample tube 1410 and a separator float 1430. The sample tube 1410 includes a sidewall 1412. The separator float includes a main body portion 1432 having a top end 1434, a bottom end 1436. At least one support member 1440 protrudes from the main body portion. The main body portion and the support member 1440 define an annular volume 1470. In particular embodiments, bottom support member 1444 extends radially from the bottom end 1436. In further embodiments, the bottom support member is present, and a top support member 1442 also extends radially from the top end 1434.

A hollow internal cavity 1456 is present within the main body portion. The internal cavity 1456 is connected to the annular volume 1470 by one or more one-way valves 1454 permitting fluid to flow into the hollow internal cavity 1456. Put another way, the one-way valves are oriented to open when the pressure inside the hollow internal cavity is lower than the pressure in the annular volume. In particular embodiments, the one-way valve is proximal to the bottom end 1436 of the main body portion or the bottom support member 1444. A plug 1458, similar to a stopper, may be present at the top end 1434 of the main body portion for accessing the hollow internal cavity 1456. A syringe can be used to penetrate the plug 1458 and access the hollow internal cavity 1456.

The apparatus of FIG. 15 is generally used as described above. During centrifugation, the pressure difference between the annular volume 1470 and the hollow internal cavity 1456 is sufficiently large so as to cause the one-way valve 1454 to open. Buffy coat constituents can then enter the hollow internal cavity 1456 during centrifugation. After centrifugation, the pressure difference is reduced and the one-way valve 1454 closes, trapping buffy coat constituents in the hollow internal cavity 1456. A removal device, such as a pitot tube or syringe, is inserted into the hollow internal cavity 1456 through the plug 1458 to remove buffy coat constituents.

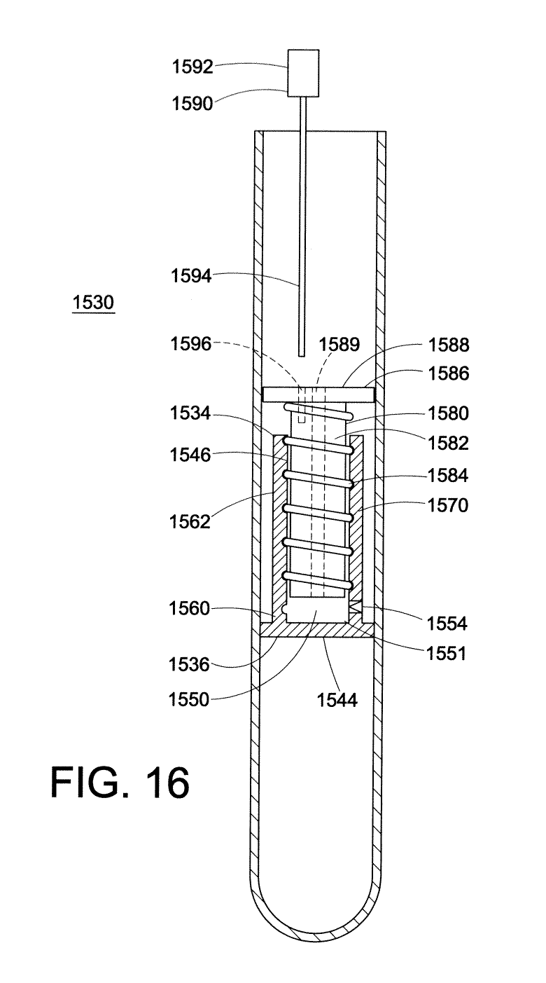

FIG. 16 shows another exemplary embodiment. Separator float 1530 includes a first main body portion 1560 and a second main body portion 1580. The first main body portion 1560 comprises a sidewall 1562 that defines a central bore 1550. The sidewall has a top end 1534 and a bottom end 1536, and the central bore 1550 is accessible from the top end. A bottom support member 1544 extends radially from the bottom end 1536 of the sidewall. A first thread 1546 is located within the central bore. One or more one-way valves 1554 located in the sidewall 1562 permit fluid to flow into the bottom end 1551 of the central bore 1550 from the annular volume 1570. Put another way, the one-way valves are oriented to open when the pressure inside the central bore 1550 is lower than the pressure in the annular volume 1570. The one-way valve is generally located proximal to the bottom support member 1544.

The second main body portion 1580 comprises a center portion 1582 that is sized to fit within the central bore 1550. A complementary thread 1584 is located on the center portion 1582 and engages the first thread 1546. A top support member 1586 extends radially from a top end 1588 of the second main body portion. A plug 1589, similar to a stopper, may be present through the top support member 1586 and the center portion 1582 for accessing the central bore 1550.

The apparatus of FIG. 16 is generally used as described above. In use, the float 1530 is completely threaded so that the central bore 1550 is filled by the center portion 1582. Put another way, the top end 1534 of the first main body portion 1560 contacts the top support member 1586 of the second main body portion 1580. After centrifugation and reduction of the rotational speed, the buffy coat constituents are located in the annular volume 1570. The second main body portion 1580 is then unscrewed from the first main body portion 1560 to increase the internal volume of the central bore 1550. This action reduces the pressure inside the central bore 1550, opening one-way valve 1554 and evacuating the buffy coat constituents into the central bore. A removal device, such as a pitot tube or syringe 1599, can be inserted into the central bore 1550 through the plug 1589 to remove buffy coat constituents. Alternatively, the second main body portion can be partially unscrewed to evacuate the buffy coat constituents. The float is then removed from the sample tube, the second main body portion is completely unscrewed, and the buffy coat constituents can be poured out or otherwise retrieved from the central bore 1550 of the first main body portion.

The second main body portion is unscrewed using a key. As depicted here, the key 1590 comprises a handle 1592 and an interface 1594 that engages a keyhole 1596 present on the top end 1588 of the second main body portion.

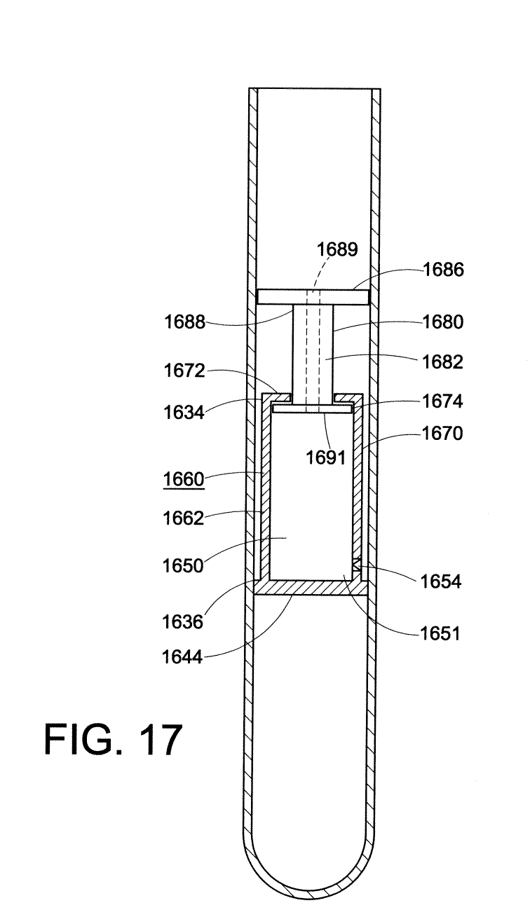

FIG. 17 shows a third exemplary embodiment of a separator float 1630. Separator float 1630 includes a first main body portion 1660 and a second main body portion 1680. The first main body portion 1660 comprises a sidewall 1662 that defines a central bore 1650. The sidewall has a top end 1634 and a bottom end 1636, and the central bore 1650 is accessible from the top end. A bottom support member 1644 extends radially from the bottom end 1636 of the sidewall. One or more one-way valves 1654 located in the sidewall 1662 permit fluid to flow into the bottom end 1651 of the central bore 1650 from the annular volume 1670. Put another way, the one-way valves are oriented to open when the pressure inside the central bore 1650 is lower than the pressure in the annular volume 1670. The one-way valve is generally located proximal to the bottom support member 1644.

The second main body portion 1680 comprises a center portion 1682 that is sized to fit within the central bore 1650. A top support member 1686 extends radially from a top and 1688 of the second main body portion. A plug 1689, similar to a stopper, may be present through the top support member 1686 and the center portion 1682 for accessing the central bore 1650.

The apparatus of FIG. 17 is similar to the apparatus of FIG. 16, but the two main body portions slide apart instead of being unscrewed to increase the internal volume and reduce the pressure in the central bore 1650, thus evacuating buffy coat constituents into the central bore 1650. In this regard, the first main body portion 1660 may include a first lip 1672 at the top end 1634 of sidewall 1662 and the second main body portion 1680 may include a second lip 1674 at the bottom end 1691 of the center portion 1682, the two lips cooperating to form a stop 1676 that ends travel of the main body portions, so the first and second main body portions do not separate.

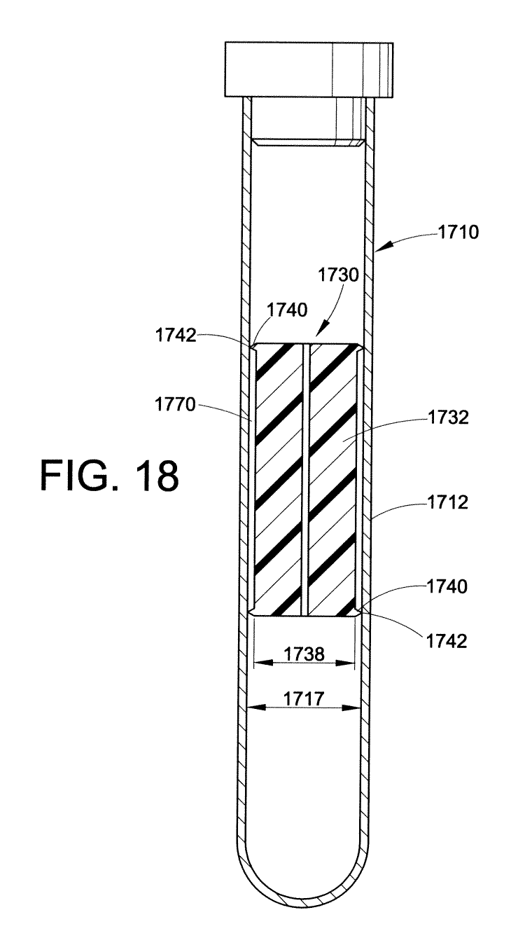

FIG. 18 is another exemplary embodiment of a separator float. The sample tube 1710 is formed from a sidewall 1712. The float 1730 includes a main body portion 1732 and two support members 1740 located at opposite axial ends of the float. The float is sized to have an outer diameter 1717 of the support members 1740 which is greater than the inner diameter 1738 of the main body portion 1732, to form an annular volume 1770. Here, the top and bottom support members 1740 have a sharp circumferential edge 1742. In other words, a pointed perimeter or circumference is provided along the outer diameter 1738 of each support member 1740. After centrifugation, buffy coat constituents are trapped in the annular volume 1770. The sample tube is then compressed against at least one of the top and bottom support members. Under compression, the sharp edge(s) 1742 out through the tube sidewall 1712, yielding a broken section of the tube containing the float and expanded buffy coat constituents. The tube may be compressed against the float at only the top support member, only the bottom support member, or at both support members. The order in which the tube is compressed against a support member is not believed to be critical. This allows the sample tube to be broken to get access to the float and the buffy coat layers trapped in the annular volume 1470. Of course, the float may also include other intermediate support members, such as the axial ridges or circumferential ridges shown in FIGS. 7-9, helical ridges, or bumps such as those shown in U.S. Pat. No. 7,074,577, the disclosure of which is fully incorporated by reference herein. Such intermediate support members would not have the sharp circumferential edge described in this paragraph.

While particular embodiments have been described, alternatives, modifications, variations, improvements, and substantial equivalents that are or may be presently unforeseen may arise to applicants or other skilled in the art. Accordingly, the appended claims as filed and as they are amended are intended to embrace all such alternatives, modifications, variations, improvements, and substantial equivalents.

1-271. (canceled)

272. A volume-occupying separator float comprising:
a main body portion;
one or more intermediate support members extending radially from the main body portion to form at least one well in a volume surrounding the main body portion; and,
at least one septum within the main body portion, the at least one septum allowing access to a particular well from a top end of the main body portion.

273. The separator float of claim 272, wherein the one or more intermediate support members consist of a plurality of axially oriented ridges.

274. The separator float of claim 272, wherein the one or more intermediate support members consist of a plurality of circumferentially oriented ridges.

275. The separator float of claim 272, wherein the one or more intermediate support members consist of a plurality of axially oriented ridges intersecting with a plurality of circumferentially oriented ridges.

276. The separator float of claim 272, further comprising a plurality of septums, each septum allowing access to a particular well.

277. The separator float of claim 272, further comprising a plurality of septums, wherein at least two septums allow access to a particular well.

278. The separator float of claim 272, wherein the float has a specific gravity of from about 1.029 to about 1.089.

279. A volume-occupying separator float comprising:
a main body portion having a top end and a bottom end;
a bottom support member extending radially from the bottom end of the main body portion; and
a plurality of ridges extending radially from the main body portion and extending axially between the top end of the main body portion and the bottom support member to form at least one axially extending flute.

280. The separator float of claim 279, consisting of a plurality of axially extending flutes.

281. The separator float of claim 279, wherein the float has a specific gravity of from about 1.029 to about 1.089.

282. A volume-occupying float comprising:
a main body portion having a top end, a bottom end, and n sides, wherein n is an integer greater than one; and
a plurality of ridges, each ridge extending laterally away from the main body portion and extending axially from the top support member to the bottom support member to form n axially-oriented wells, each well having an exterior surface.

283. The float of claim 282, further comprising at least one of a top support member extending laterally away from the top end of the main body portion or a bottom support member extending laterally away from the bottom end of the main body portion.

284. The float of claim 282, wherein the float is adapted to be unfolded so that the exterior surfaces of the wells can lie substantially in the same plane.

285. The float of claim 282, wherein the sides of the main body portion have the same length.

286. The float of claim 282, wherein the float has a specific gravity of from about 1.029 to about 1.089.

287. A volume-occupying float comprising:
a first main body portion having a top end and a bottom end;
one or more support members protruding from the first main body portion;
a hollow internal cavity within the first main body portion; and
wherein the first main body portion and the one or more support members define an annular volume; and
one or more one-way valves permitting flow from the annular volume to the hollow internal cavity.

288. The separator float of claim 287, further comprising:
a first thread located within the hollow internal cavity; and,
a second main body portion comprising a center portion sized to fit within the hollow internal cavity, a complementary thread located on the center portion for engaging the first thread of the first main body portion.

289. The separator float of claim 287, further comprising:
a second main body portion comprising a center portion sized to slidably fit within the hollow internal cavity.

290. The separator float of claim 287, further comprising a plug at the top end of the main body portion for accessing the hollow internal cavity.

291. A kit for separating blood, the kit comprising:
a flexible sleeve; and
a separator float, the separator float comprising:
a main body portion and one or more support members protruding from the main body portion to engage the sidewall of the flexible sleeve, wherein said main body portion together with an axially aligned portion of said sidewalls define an annular volume therebetween; and wherein said support members traverse said annular volume to produce n wells;
wherein the flexible sleeve is capable of sealing at least a portion of buffy coat with the annular volume.
